(19) United States
(12) Patent Application Publication
(10) Pub. No.: US 2013/0262827 A1
(43) Pub. Date: Oct. 3, 2013

(54) APPARATUS AND METHOD USING HYBRID LENGTH INSTRUCTION WORD

(71) Applicants: Jonathan D. RIEHL, Austin, TX (US); Christopher R. Cope, North Potomac, MD (US)

(72) Inventors: Jonathan D. RIEHL, Austin, TX (US); Christopher R. Cope, North Potomac, MD (US)

(73) Assignee: Resilient Science, Inc., Bethesda, MD (US)

(21) Appl. No.: 13/431,602

(22) Filed: Mar. 27, 2012

(51) Int. Cl. G06F 9/38

(52) U.S. Cl. 712/208; 712/E09.028; 712/E09.049

(57) ABSTRACT

A parallel processing computer architecture utilizes hybrid length instruction words that mix vectors and Very Long Instruction Word (VLIW) or other parallel processing instructions to enable data-parallel and task-parallel instructions to be run simultaneously with reduced redundancy and code size inefficiency.

### BACKGROUND OF THE INVENTION

1. Field of the Invention

This invention relates to parallel processing computer architectures, and in particular to an apparatus and method that utilizes a hybrid length instruction word, the hybrid length instruction word allowing mixtures of vectors and Very Long Instruction Word (VLIW) or other parallel processing instructions to enable data-parallel and task-parallel instructions to be run simultaneously with reduced redundancy and code size inefficiency.

The apparatus of the invention includes a decoder and instruction dispatcher for hybrid length instruction words containing mixtures of vectors and instructions.

The invention also relates to a non-transitory storage medium for program code containing hybrid length instruction words containing mixtures of vectors and instructions.

2. Description of Related Art

Parallel computation is commonly performed using one of two computational paradigms:
Single Instruction, Multiple Data (SIMD), and
Multiple Instruction, Multiple Data (MIMD).
   In the SIMD paradigm, a single operation is simultaneously applied to each datum in a set of information. Other terms for this kind of parallelism include data parallelism or vector processing. The SIMD paradigm has inspired multiple computer and instruction set designs, including the Cray supercomputer architectures, the SSE instruction set in the Intel micro-architecture, and graphics processing units (GPUs) such as Nvidia's CUDA architecture.

The MIMD paradigm also operates on a set of data, but each subset or datum is handled by a differing computational instruction. Another term for this kind of parallelism is task parallelism. Multicore and networks of computers operate in the MIMD paradigm.

The present invention utilizes instructions that mix vectors, which are a characteristic of SIMD processing, with a type of MIMD instruction known as the Very Large Instruction Word (VLIW). VLIW processors are a type of MIMD processor, but instead of instruction scheduling being done by independent threads of control, all processing elements are scheduled in lock-step using an instruction word composed of individual instructions for each processing element. The Transmeta processor is an example of a processor that utilizes the VLIW microarchitecture. Information on VLIW can be found at http://en.wikipedia.org/wiki/VLIW.

In a MIMD architecture, when the same instruction is to be applied to different subsets or data, the conventional approach is to schedule the same instruction in multiple slots. In that situation, MIMD has an inherent disadvantage relative to MIMD architectures, including VLIW, because of the redundancy, and consequent code size inefficiency.

The Hybrid Length Instruction Word architecture of the present invention is a multiple instruction architecture that uses VLIW instructions, but allows mixtures of vector and VLIW instructions in the same instruction word. This allows programs to run both data parallel and task parallel instructions simultaneously without the code size inefficiency of conventional VLIW and other MIMD processors.

### SUMMARY OF THE INVENTION

The invention provide a parallel processing architecture having improved code size efficiency, combining SIMD-like vector instructions with VLIW instructions to create a hybrid instruction having the multiple instruction capabilities of MIMD with the code size efficiency of SIMD. The resulting hybrid instruction may be referred to as a Hybrid Length Instruction Word (HLIW).

The manner by which the hybrid length instruction word reduces code size can be understood from the following example:

A VLIW architecture might perform a vectorized add using several processing elements, as follows:

ADD, ADD, ADD, ADD

The vectorized instruction the preferred HLIW, on the other hand, might appear as follows:

VADD 4

Assuming that each datum (referring to either an operation code such as ADD or VADD, or an integer constant, such as 4) in the instruction requires a byte of data, the VLIW instruction requires a four byte instruction, whereas the HLIW only requires two bytes, resulting in a 50% code size reduction for this particular instruction.

Of course, further compression techniques may be applied across instructions to allow removal of additional redundant information from a user program. A machine of the technique might use a decoder that employs state, such as a register file, to achieve even greater reductions in code size.

Those skilled in the art will appreciate that the hybrid length instruction word can be used to emulate both SIMD and MIMD architectures, and is not limited to a particular parallel processing architecture or system.

### BRIEF DESCRIPTION OF THE DRAWINGS

FIG. 1 is a schematic diagram illustrating a decoder and instruction dispatcher for hybrid length instructions.

### DETAILED DESCRIPTION OF THE PREFERRED EMBODIMENTS

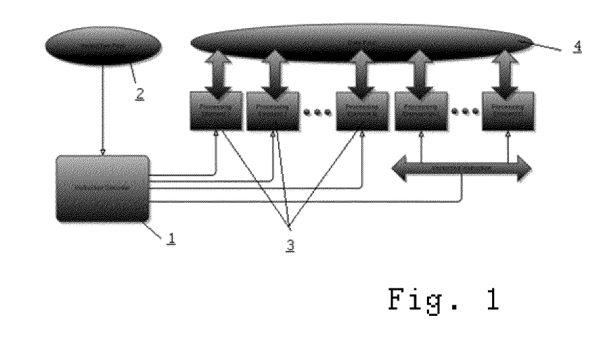

FIG. 1 shows the overall design of computing system that includes a decoder and instruction dispatcher 1 arranged to decode and dispatch hybrid length instruction words. The decoder 1 decodes instructions from an instruction pool 2, which is any register or memory device containing instructions to be decoded, and dispatches the decoded instructions to one or more of N processing elements 3 to cause the processing elements to perform processing tasks, including retrieval and return of data to a data pool 4, which can be any register or memory device accessible by the processing elements 3 under control of instructions issued by the decoder/instruction dispatcher.

When a hybrid length instruction word is received by decoder and instruction dispatcher 1, decoder/instruction dispatcher 1 recognizes a demarcation point in the instruction word and identifies an instruction as a vector instruction. The decoder/instruction dispatcher 1 then issues the instruction over processing elements M=1 through N by executing the following operations or steps:

A. Read
(a) The decoder/instruction dispatcher executes a read function [e.g., read_HLIW ( )] that causes the decoder/instruction dispatcher 1 to read an instruction and the corresponding vector or “code offset,” as well as the current status of a program counter.
(b) The decoder/instruction dispatcher 1 then checks whether the instruction word contains a flow control instruction, in which case the program counter jumps to a designated count, or an instruction that needs to be decoded and dispatched to a processing element or elements, in which case the instruction and vector offset are decoded so that the tasks required to carry out an instruction can be dispatched to appropriate processing elements for execution, after which the program counter is incremented to the next instruction.

B. Execute
(a) Each processing task is dispatched to a processing element 3 according to the vector offset.
(b) If the processing element is not available, then the instruction is terminated or suspended (NOP).
(c) The tasks (by way of example, for executing an “ADD” instruction) are carried out in parallel by available processing elements 3, in connection with “push and pop” data-retrieval and storage operations with respect to data pool 4.

C. Synchronize

The processing elements are all synchronized.

This procedure may be expressed in VLIW syntax as follows:

```
PARALLEL for PEID in range(len(PEs)): // For each PE, the
following is done in parallel:
    while not stopped:
        if PEID == 0:
            HLIW = read_HLIW((memory + code_offset),
        program_counter)
            if is_flow_control(HLIW):
                program_counter =
            handle_flow_control(HLIW)
                if program_counter < 0:
                    stopped = True
            else:
                (memory + instruction_register_offset)
            = decode(HLIW)
                program_counter += len(HLIW)
        else:
            switch (memory +
        instruction_register_offset)[PEID]:
                case NOP:
                    break
                case ADD:
                    push(pop( ) + pop( ))
                    break
                ...
        synchronize( ) // All PE's synchronize on this
    point.
                    * * * *
```

Task parallelism in hybrid length instruction word architectures can be further generalized to processing groups (PG's), which are collections of processing elements. Each processing group has a unique decoder PE that is responsible for decoding HLIW instructions for that PG. As a result, there are multiple coding streams and instruction lengths, one for each processing group. Processing groups are only required to synchronize over the set of processing elements in the group. A unique flow control construct can reformulate processing groups instead of halting the machine, by varying the above described procedure to include additional stop and reformulate (e.g., “reformulate pgs”) steps, starting with a global stop and reformulate to initialize all processing elements, followed at appropriate times by individual group stop and reformulate steps that enable synchronizing of processing elements with respective groups without the need to halt operations carried out by other groups. An example of the VLIW procedure set forth above with the additional global and group synchronizations, is as follows:

```
global stopped, reformulate_pgs
PARALLEL for PEID in range(len(PEs)): // For each PE, the
following is done in parallel:
    if PEID == 0:
        stopped = initialize_program_groups(memory +
    pg_table)
        reformulate_pgs = False
    synchronize(0) // All PE's synchronize on this point.
    while not stopped:
        PGID = (memory + pg_assignment_table)[PEID]
        while not reformulate_pgs:
            switch (memory +
        instruction_register_offset)[PEID]:
                case DECODE:
                    HLIW = read_HLIW((memory +
                      pg_table + code_offset),
                      program_counter[PGID])
                    if is_flow_control(HLIW):
                        program_counter =
                    handle_flow_control(HLIW, PGID)
                        if program_counter[PGID] < 0:
                            pg_table =
                        −program_counter[PGID]
                            reformulate_pgs = True
                    else:
                        (memory +
                    instruction_register_offset) =
                    decode(HLIW)
                        program_counter[PGID] +=
                    len(HLIW)
                    break
                case NOP:
                    break
                case ADD:
                    push(pop( ) + pop( ))
                    break
                ...
            synchronize(PGID) // Only PE's in the PG
        synchronize on this point.
        synchronize(0)
        if PEID == 0:
            stopped = initialize_program_groups (memory +
        pg_table)
            reformulate_pgs = False
        synchronize(0)
                    * * * *
```

Although specific procedures for carrying out parallel processing of instruction words in hybrid format are described above in a preferred VLIW format, it will be appreciated that other parallel processing instruction formats may be used, and that the method steps described above may be replaced by any suitable method steps capable of decoding and executing a hybrid instruction consisting of both an instruction to be carried out by multiple processing elements and a vector offset may fall within the scope of the invention.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

We claim:

1. A parallel processing method, comprising the steps of:
reading a hybrid length instruction word, wherein the hybrid length instruction word includes an instruction consisting of multiple tasks and a vector for enabling the multiple tasks to be dispatched to a plurality of processing elements for parallel execution;
decoding the instruction and the vector; and
dispatching the multiple tasks to the plurality of processing elements based on the vector.

2. A method as claimed in claim 1, wherein said instruction is a VLIW instruction.

3. A method as claimed in claim 1, wherein said processing elements are arranged in groups and each respective group has a unique decoder responsible for processing hybrid length instruction words for the respective group, said method further comprising the step of synchronizing processing elements over an individual group without stopping processing of instructions by processing elements of a different group of processing elements.

4. Parallel processing apparatus, comprising:
a plurality of processing elements;
a memory device for storing instructions including at least one hybrid length instruction word, wherein the hybrid length instruction word includes an instruction consisting of multiple tasks and a vector for enabling the multiple tasks to be dispatched to a plurality of processing elements for parallel execution;
an decoder/dispatcher device for reading said hybrid length instruction word from said memory device, decoding said instruction and said vector, and dispatching said instruction to a plurality of processing elements for parallel execution of said multiple tasks; and
a data store connected to said plurality of processing elements to supply data to and receive results of said multiple tasks.

5. Apparatus as claimed in claim 4, wherein said instruction is a VLIW instruction.

6. Apparatus as claimed in claim 4, wherein said processing elements are arranged in groups, and further comprising a unique said decoder/dispatcher device for each said group of processing elements.

7. A non-transitory storage medium on which is stored program code including a plurality of hybrid length instruction words, said hybrid length instructions words including instructions consisting of multiple tasks and vectors for enabling the multiple tasks to be dispatched to a plurality of processing elements for parallel execution.

8. A non-transitory storage medium as claimed in claim 7, wherein said instruction is a VLIW instruction.
